(19) United States
(12) Patent Application Publication
(10) Pub. No.: US 2025/0205741 A1
(43) Pub. Date: Jun. 26, 2025

(54) METHOD AND DEVICE FOR PRETREATING INSERT ELEMENTS FOR INJECTION-MOLDED PARTS

(71) Applicant: HEKUMA GmbH, Hallbergmoos (DE)

(72) Inventor: Felix SCHELAUSKE, Günding (DE)

(21) Appl. No.: 18/848,414

(22) PCT Filed: Mar. 17, 2023
(86) PCT No.: PCT/DE2023/100210

§ 371 Date: Sep. 18, 2024

(30) Foreign Application Priority Data
Mar. 18, 2022 (DE) 10 2022 106 453.0

(51) Int. Cl. B07B 1/24; B08B 5/04

(52) U.S. Cl. CPC B07B 1/24; B08B 5/043

(57) ABSTRACT

Method for the pretreatment of insert elements for the fitting of injection molded parts, in particular pipette tips, wherein the insert elements are transported as bulk material from a supply container to a storage container, the bottom of which is formed as a sieve plate with corresponding openings or bores, into which the insert elements are preferably transferred by means of shaking motion for a further transport or a use in the fitting process of the injection molded parts, characterized by the steps: —introducing of the insert elements into a rotatable transport drum, which is provided with openings or through-holes of such a shape or size that the insert elements remain in the transport drum during the pretreatment; —rotating of the transport drum at least intermittently about an axis X, about which the transport drum is rotatably mounted; and —transporting of the insert elements.

The present invention relates to a method and a device for the pretreatment and conveying of insert elements, which are provided for a fitting of injection-molded parts, in particular of pipette tips manufactured by means of injection molding, into which the insert elements are inserted in order to complete the pipette tips for use.

In pipette tips or other injection-molded parts, frequently insert elements for example in the form of filter elements are used, which are provided as separate parts and allocated to a respective injection-molded part. For example, pipette tips which during later use are exposed to the risk of a contamination by foreign substances, are provided with insert elements in the form of cylindrical filter elements made of a porous material, which are inserted into the pipette tips. Such filter elements are used in high performance automation systems for the processing and handling of such synthetic material injection-molded parts like pipette tips, wherein difficulties occasionally arise in the assembly lines with regard to the handling, further processing and use of such cylindrical filter elements.

In known filter assembly lines of such automation systems, for example cylindrical filter elements are placed as bulk material in a storage container, the bottom of which is formed in the shape of a sieve plate with predefined bores or openings. The openings of the sieve plate of such storage containers have diameters which substantially correspond to those of the filter elements and as the case may be are somewhat larger or have a conical extension upwards in order to allow the inserting of the filter elements into the bores in the sieve plate. The filter elements, as flaw-free good parts for the fitting of the injection-molded parts, are then removed from the sieve plates and conveyed further, while the bad parts not fitting into the openings of the sieve plate have to be removed.

The interference-free process of a treating of the filter elements in such a system strongly depends, however, on the quality and size accuracy of the supplied filter elements from a preceding manufacturing process of the filter elements. For example, it can occur that at the edges of the cylindrical filter elements a burr is present, or that two or more filters adhere together. Likewise, it can occur that parts are broken off at the filter elements or that impurities, for example as chippings or material particles, are present at the outsides of the filter elements or in the filter elements provided as bulk material. This can lead to difficulties and down times of the systems in the sieve plate and in the subsequent process and in particular in the process for the fitting of injection-molded parts as described above, and to an impairment in the quality of the end products.

In view of the above, it is the object of the present invention to provide a method and a device for the pre-treating of the insert elements, like for example filter elements for a fitting of injection-molded parts, with which the handling and reliable fitting of insert elements in injection-molded parts is achieved as flaw-free as possible and with reliable discharging of bad parts before the fitting of the injection-molded parts. Furthermore, it is the object of the present invention to provide such a method and such a device in which an also automatized handling of the step of the providing and processing of insert elements for injection-molded parts is achieved with a high quality of the end products.

This object is solved by means of a method with the steps according to claim 1 and a device having the features of claim 13. Advantageous embodiments and developments of the invention are the subject matter of the dependent claims.

According to the invention, a method for the pre-treating of insert elements for the fitting of injection-molded parts, in particular pipette tips, is provided wherein the insert elements are transported as bulk material from a supply container to a storage container, the bottom of which is formed as a sieve plate with corresponding bores or openings, into which the insert elements by means of shaking motion are preferably conveyed for a further transport or a use in the fitting process of the injection-molded parts, wherein the method according to the invention is characterized by the steps:
Placing the insert elements in a rotatable transport drum, which is provided with openings or through-holes of such a shape or size that the insert elements remain in the transport drum during the pretreatment;
Rotating of the transport drum at least intermittently about an axis X, about which the transport drum is rotatably mounted;
Conveying of the insert elements through the transport drum, so that the insert elements repeatedly come into contact with the inside wall of the transport drum and mutually with one another over a predetermined length of time of a pretreatment;
Discharging of the pretreated insert elements from the transport drum.

According to the invention, the insert elements for the injection-molded parts are introduced into a preferably cylindrical transport drum, which is rotatably supported about an axis X and which is provided with openings or through-holes of such a shape or size that the insert elements remain in the transport drum during the pretreatment. The transport drum is rotated such that clingages, projections or burrs are removed from the insert elements positioned therein. Thereby, the transport drum is preferably arranged between a supply container and a storage container provided at its discharge end and can be moved in its at least intermittent rotation movement either continuously or periodically or also in a combination movement, on the one hand to convey the insert elements, and on the other hand, to carry out a treatment, in particular a surface treatment, at the insert elements at the same time in this process. By means of the surface treatment, for example burrs at the edges can be removed or projecting material component parts can be abraded or a plurality of insert elements adhering to one another can be separated from one another and thus isolated. For this, the insert elements are conveyed through the transport drum with at least an intermittent rotation of the transport drum such that the insert elements repeatedly come into contact with the inside wall of the transport drum and mutually with one another. This happens in the transport drum according to the invention by an at least intermittent rotation of the transport drum and of the contacts between the individual insert elements on the one hand, and the striking at the inside walls of the transport drum on the other hand, which quasi carries out a kind of slide-grinding process with the insert elements. The function and kind of the pretreatment can also be increased if required, in that a profiling with protrusions and/or recesses is formed at least section-wise at an inner side of the transport drum.

In an embodiment of the invention, a middle dwell time of the insert elements in the transport drum is adjusted, in that the rotation movement, rotation direction, shape, inclination and/or other movement profiles at or in the transport drum are adjusted. Additionally to the middle dwell time, also kind and intensity of the surface treatment carried out at the insert elements can be adjusted effectively by means of the proposed measures.

In a further embodiment of the invention, after the predetermined middle dwell time in the transport drum, the pretreated insert elements are discharged at an outlet of the transport drum into a storage container provided for this, for the orderly inserting as bulk material into bores of the sieve plate or into a storage container for the intermediate storage of the insert elements. Due to the treatment of the outer surface, the insert elements pretreated in this way have a higher dimensional accuracy than previously and do not have any projecting elements like burrs that interfere during handling. The inserting into the bores provided for this in corresponding diameters or accordingly shaped openings in the sieve plate or the further processing in other subsequent handling steps in the automatization systems is therefore possible in a flaw-free manner. The pretreatment of the insert elements according to the invention has the advantage that the standing times and down times of such systems are considerably reduced and fewer rejects can be achieved in the manufacture of such injection-molded parts fitted with insert elements, like pipette tips. With the fewer rejects, higher quality and dimensional accuracy of the insert elements, a secure handling in such fitting processes of pipette tips can also be achieved.

According to a further advantageous embodiment of the method according to the invention, a combined conveying and pre-treating of the insert elements takes place in the transport drum, in particular a slide grinding, for the deflashing, isolating or cleaning of the insert elements, with conveying onward at the same time. Therefore, according to the invention, two combined method steps are carried out inside the transport drum preferably in an automatized manner: for one thing, starting from the supply container, the insert elements are conveyed, by the transport drum or by additional means which are present at or in the transport drum, onward to a storage container. These means can be mechanical means, like for example conveying elements, vanes, slider parts or the like, which function in connection with the partial rotation movement of the transport drum. Alternatively, these means for the transport of the insert elements in this step can also be provided from outside at the transport drum, for example by pneumatic nozzles, actuators or the like. Also, the means can be realized by simple gravity and an inclined position, so that during a rotation movement of the transport drum the insert elements are quasi automatically moved away from an inlet side to an outlet side of the transport drum. In combination with this, in the same method step according to the invention the pretreatments or surface finishing of the insert elements are also carried out.

In the scope of this invention, such a pretreatment means that the insert elements are handled with regard to their accuracy of shape, cleanness, isolation etc. such that a waste in the providing of insert elements and in the fitting of pipette tips due to bad parts is as far as possible avoided, at least, however, greatly reduced. The pretreatment provided in combination with the conveying of the insert elements can take place in different ways. Preferably, this concerns a treatment by means of a kind of slide grinding, that is, due to a rotation movement of the transport drum, the individual insert elements come into contact with one another and with outer surfaces or corresponding projections, protrusions or the like at the inner walls of the transport drum, in order to prepare the insert elements in dimensional accuracy, shape accuracy, and the like, such that correspondingly, for the subsequent processing steps, they are optimally configured in particular to bores of a sieve plate of the storage container or of a handling system, which bores are configured to the dimensions of the diameters of the insert elements. In this step of the pretreatment of the insert elements, the insert elements are treated for example by slide grinding or a similar method, such that a deflashing, an isolating of a plurality of insert elements adhering together, and a cleaning of the insert elements takes place. According to the invention, in this way considerable technical advantages with regard to the quality and effectiveness in the manufacture and providing of the insert elements, are achieved.

According to a further advantageous embodiment of the invention, the method is characterized by sorting out of bad parts of the insert elements before or during a placing into the storage container with the sieve plate. After the pretreatment and the conveying of the insert elements through the transport drum, in this way good parts are sorted out from bad parts of the insert elements with regard to the dimensional accuracy and shape accuracy or possible damage at the insert elements. In this step of a sorting out, with corresponding means like for example optical sensors, pre-sorting screens, mechanical or pneumatic actuators or nozzles, the pretreated insert elements are divided into good parts and bad parts. Therefore, subsequently only good parts reach the storage container. The further processing and use of the insert elements for the fitting of the injection-molded parts is therefore ensured easily and with a high quality in the insert elements used, for example the cylindrical filters for pipette tips. For the step of a sorting out of bad parts according to the invention, different measures, devices and means can be used which are suitable for the recognizing and sorting out of bad parts.

According to a further advantageous embodiment of the invention, a suctioning-off and/or a discharging of bad parts of the insert elements takes place at or before the sieve plate of the storage container. The insert elements positioned before the sieve plate, which for example have not gone into the openings or bores of the sieve plate provided for them, are removed in this step by means of a pneumatic means, namely a suctioning-off means, or alternatively by means of a mechanical means, like for example a slide, ejecting means, a rake or the like. A discharging of bad parts can also take place directly at the sieve plate, such that by means of a striking plate or discharge unit provided with projecting pins, bad parts which have become jammed in the openings of the sieve plate can be removed from there, from below. By means of this measure of the suctioning-off and/or discharging of bad parts, the amount of good parts which are flaw-free with regard to size accuracy and shape of the insert elements at the end of the method is considerably increased.

According to a further advantageous embodiment of the method according to the invention, a pre-sorting screen is used for an ejecting of bad parts of the insert elements after the discharging from an outlet or outlet opening of the transport drum. Such a pre-sorting screen can be mounted for example between the transport drum and the downstream storage container. A pre-sorting screen can be formed by means of corresponding shape of the screen openings such that after the insert elements penetrate through the pre-sorting screen, only good parts subsequently find their way out. Different shapes and embodiments of such pre-sorting screens can be used in the scope of the invention. The pre-sorting screen can for example also be combined with an ejecting means like a suctioning-off or discharge process.

According to a further advantageous embodiment of the invention, the method is characterized by adjusting of a predetermined inclination of the transport drum at an angle α relative to the horizontal for a defined middle length of time or dwell time of the insert elements for the pretreatment of the insert elements in the transport drum. For this, the transport drum is provided with a means with which the angle of inclination α of the rotational axis X of the transport drum can be easily displaced in relation to the horizontal, for example in a range of 0° to 30°. With this measure, the insert elements introduced at the inlet side of the transport drum are automatically conveyed by means of gravity and in combination with the at least intermittent rotation movement of the transport drum from the inlet side to the outlet side facing the storage container, with at the same time pretreatment inside the transport drum by means of the shape of the transport drum (for example round or angular cross-section), possible profilings or other measures inside the space of the transport drum. Hereby, an effective adjusting of the average intended dwell time and length of time of the pretreatment of the insert elements can be specifically determined and varied with relatively simple structural measures. The conveying onward takes place quasi due to gravity and in connection with the rotation movement of the drum, with or without support of further profilings in the inside of the transport drum. A dwell time adjustable according to requirement, and thus an adjustable length of the pretreatment of more or less insert elements to be handled, can therefore be achieved with a high-quality result and a large amount of good parts, that is, a lower rejection rate.

According to a further advantageous embodiment of the invention, the method is characterized by conveying and pretreating of the insert elements in the transport drum in a combined manner by means of at least a helical profiling or a section of a helical or vane-shaped profiling at the inside of the transport drum. Such a profiling extending helical-shaped or helix-shaped in the inside along the cylindrical transport drum can for example be formed by a projection or a recess. The helical, spiral-shaped, or helix-shaped profiling has the advantage that also due to a rotation movement alone, a conveying onward of the insert elements introduced as bulk material takes place at the same time as the pretreating by means of, for example, a slide grinding or a kind of vibrating in the inside of the transport drum. In this way, possible burrs at edges of the insert elements are securely removed and residue, dust or chipping-offs from the process are sieved out through the openings or through-holes (slots) of the transport drum. In this way, the conveying onward for example also without a tilt or with a very slight tilt of the transport drum in relation to the horizontal is made possible, and a pretreatment can take place at a relatively short distance inside the transport drum provided for this. Not least, the insert elements therefore come into contact more frequently with the profiling and with one another due to the more thorough mixing during the treatment by means of the helical shape.

According to a further advantageous embodiment of the invention, the method is characterized by sieving out and discharging of material particles, dirt particles or fragments from the process of the pretreatment of the insert elements out of the transport drum via the openings or through-holes. For this, corresponding measures are provided at or in the transport drum additionally to the openings (bores) or through-holes and slots, for example the corresponding material particles or dirt particles are actively suctioned out of the inside of the transport drum or alternatively simply ejected from the process by gravity and a catchment container below the transport drum in corresponding dimension and embodiment. A compressed air- or fluid impingement can also be used for the ejecting of particles. In this way, during the further processing and the fitting of the injection molded parts it is avoided that such particles and dirt particles lead to rejects or down times of the system. In this way, it is effectively avoided that insert elements not fitting into the holes of a sieve plate for example of a storage container are conveyed onward as good parts, or enter there and then become jammed in the holes or bores of the sieve plate. In this way, it is avoided that the automatized process is unnecessarily interrupted or that time-consuming measures by hand are required in order to be able to continue the process with qualitatively correct insert elements with exact dimensions.

According to a further advantageous embodiment of the invention, the method is characterized by impinging of the transport drum with compressed air from a lower side for a specific swirling of the insert elements during the pretreatment. With such a supply of compressed air or pressurized air from below to the transport drums provided with through-holes or bores, the insert elements located in the inside are again more thoroughly swirled and quasi abraded and cleaned and deburred against one another and at the inner walls of the transport drum. The impinging with compressed air is a structurally simple means in order to achieve an even faster pretreatment in the transport drums of the method according to the invention. The length of process can thereby be further reduced with nevertheless a quasi fully automatic process of a combined onward conveying and pretreatment for the cleaning, deburring or isolating of the insert elements.

According to a further advantageous embodiment of the invention, the method is characterized by an at least intermittent rotation movement of the transport drum during the process of the pretreatment of the insert elements, preferably a continuous rotation movement, an alternating forwards/backwards rotation movement, an intermediately stopped rotation movement or a rotation movement in pilger step (a plurality of forward movements, one backward movement) or a combination thereof. By means of such an at least intermittent rotation movement of the transport drum during the process of the pretreatment of the insert elements, it is achieved that the insert elements introduced as bulk material come more thoroughly into contact with one another and at the inner walls and the profilings possibly located there, and therefore, due to the friction between one another or at the walls of the transport drum or the profiling thereof, are treated in the fastest way possible in the sense of a kind of slide grinding. Projecting burrs at the edges are likewise removed quickly and ejected from the process, likewise an effective isolating of pluralities of insert elements adhering to one another can also be achieved thereby. The at least partial rotation movement of the transport drum during the process of the pretreatment can thereby preferably be a continuous rotation movement. Alternatively, also an alternating forwards/backwards rotation movement corresponding to the rotation movement of a washing machine drum can be provided or an intermediately stopped rotation movement or a rotation movement in the way of a pilger step. According to requirement, the corresponding pretreatments can thus be adapted according to the method and the insert elements to be treated. An effective pretreatment of the insert elements is therefore ensured, and the insert elements at the outlet of the transport drum are to a great extent further usable as good parts in the process of the fitting of the injection-molded parts and the further handling.

According to a further advantageous embodiment of the invention, a detection of a fill level of the downstream storage container in the transport drum is carried out for a controlling of the amount of insert elements located in the pretreatment. A fill level detection can for example take place by means of corresponding sensors at the storage container with a control unit allocated thereto and configured and adapted for this. The detection of the fill level has the advantage that the supply, onward conveying and the dwell time of the insert elements in the pretreatment step of the transport drum can be correspondingly adjusted and, in the case of further pretreatment of insert elements not being required, the process can also be stopped some of the time. Thereby, a quasi fully automatized process of placing inside, pretreatment and of the conveying onward of the insert elements in an automation system for the fitting of insert elements in injection-molded parts like pipette tips can be carried out, which has considerable technical and economic advantages in the handling of such critical single parts in the process of the fitting of pipette tips.

According to the invention, likewise a device is proposed in particular for the carrying out of the method according to the invention for the pretreatment of insert elements, in particular filter elements, for the fitting of injection molded parts, in particular pipette tips, wherein the insert elements are conveyed as bulk material from a supply container or bunker to a storage container, wherein the bottom of the storage container is formed as a sieve plate with openings or bores, into which the insert elements are conveyed by means of vibrating motions for a conveying onward or for a use in the fitting process of the injection molded parts or in another subsequent process step, characterized in that a transport drum rotatably movable about an axis X is provided between the supply container and the storage container. By means of the rotation of the transport drum, the insert elements are conveyed from an inlet side to an outlet side or outlet opening while being submitted to a treating of the surfaces, for example for the removing of burrs or the like. The insert elements collide with the inside wall of the transport drum and mutually with one another.

According to an embodiment of the invention, the transport drum is provided with openings or through-holes and bores or slots or the like having a smaller diameter than that of the filter elements or another shape or size than the insert elements. In this way, the insert elements are kept for a determined length of time in the transport drum and pretreated there according to the invention in a kind of slide-grinding process in particular according to the method described above.

According to an embodiment of the invention, the transport drum is provided at its inside at least section-wise with at least a profiling of projections and/or recesses, and means are provided for the automatic conveying of the insert elements through the transport drum from an inlet side to an outlet side with at least intermittent rotation of the transport drum for the pretreatment of the insert elements. The device according to the invention therefore has a specifically formed transport drum between a supply container and a subsequent storage container for the insert elements, which is formed such that a conveying onward or a transport in the transport drum takes place with at the same time pretreatment or processing of the filter elements in the inside of the transport drum. For this, the transport drum has means which convey the filter elements automatically from an inlet side to an outlet side as bulk material, wherein the walls of the transport drum are provided with openings and bores or through-holes and slots of smaller diameter than that of the filter elements themselves. As a transport drum, both a round cylindrical shape and a polygonal, for example hexagonal or octagonal drum can be used. Also, according to the invention, metallic drums or drums made of synthetic material can be used.

In this way and due to the at least intermittent rotation movement of the transport drum, besides the onward conveying, a specific pre-treatment process in particular of the surfaces also takes place in the transport drum: the single insert elements are abraded at the walls and mutually at one another and quasi by means of a kind of slide grinding they are deburred, cleaned and isolated, so that at the outlet end of the transport drum a higher amount of insert elements of sufficient quality and fitting dimensions can be discharged as good parts. The pretreatment serves for the compliance with the size accuracy, the cleaning and removal of dirt particles and an isolating of for example a plurality of insert elements adhering to one another from a previous manufacturing process of the insert elements. For this, the transport drum has corresponding openings or through-holes in another shape in cross-section than that of the elements or with a smaller diameter than the diameter of the insert elements themselves. Additionally, preferably at least a profiling is located in the transport drum. This increases the effect of the pretreatment. In this way, the dirt particles, clingages or small particles can be effectively removed from the inside of the transport drum, after they are removed from the insert elements. The insert elements therefore enter the storage container of the device according to the invention located downstream from the transport drum, in a cleaned and deburred way. The means for the automatic conveying of the insert elements in the inside of the transport drum can be realized in different ways, for example by means of simple gravity by a slight incline or tilt of the arrangement of the transport drum. Also, the means for the conveying in the inside of the transport drum can be active means, like for example slides or fluidic actuators like air nozzles. Also, the means for the conveying and treating of the insert elements in the inside of the transport drum can be realized as projecting elements, vanes or profilings in the transport drum.

According to an advantageous embodiment of the device according to the invention, the transport drum is provided with means for the variable adjustment of an inclined position or tilt at an angle α in relation to the horizontal, and a control unit is provided, which is formed and configured to adjust, in particular to variably adjust, the tilt of the transport drum corresponding to the intended dwell time and length of process of the pretreatment of the insert elements. By means of such an inclined position or tilt of the transport drum between an inlet side positioned higher and an outlet side positioned lower, by means of gravity the conveying onward of an at least intermittently rotating transport drum can be brought about in a simple structural way. The insert elements introduced at the inlet side as bulk material move onward piece by piece during the pretreatment in the inside of the transport drum, and after a, for example, variably adjustable dwell time and length of time of treatment of the pretreatment, they enter the storage container at the outlet end in a cleaned and deburred form and optimized with regard to isolation, so that the further processing in the subsequent fitting process of the pipette tips or the like can be easily carried out, without many rejects also in an automatic way from the sieve plate. For the adjusting of the tilt, the transport drum can be displaced slightly inclined in its longitudinal axis simply by means of corresponding actuators, for example at the pivot bearings. Also, the tilt of the transport drum can be realized by means of a displacement possibility of a drive shaft of a drive motor. Other forms of the tilt displacement corresponding to the intended dwell time of the insert elements in the transport drum, as they are used for such conveying means in automatization technology, are just as familiar to the person skilled in the art and usable in the scope of this invention with the described advantages of the combined pretreatment and transport.

According to a further advantageous embodiment of the device according to the invention, the transport drum is provided with means for the conveying onward of insert elements in the transport drum or outside of the transport drum. The means for conveying onward of the insert elements can be of very different kinds and shape, as long as they allow a transporting or conveying of the insert elements from the inlet side to the outlet side of the transport drum during their treatment. For example, in the inside of the transport drum, profilings or elements can be provided which, with or without rotation movement of the transport drum, cause a moving onward of the filter elements and at the same time effect the pretreatment. Also from outside the transport drum such transport means can be mounted, for example in the form of pneumatic actuators or the like. With this feature according to the invention in the step of the pretreatment in the transport drum the pretreatment itself, provided for the cleaning or the deburring, and also the conveying onward or the transport of the insert elements to the outlet side and the downstream storage container of the device, are caused. A fully automatic carrying out of the pretreatment step is therefore also possible without a separate handling system, like for example a gripper or a transfer unit.

According to a further advantageous embodiment of the invention, the means for the conveying of the insert elements through the transport drum are formed in the form of profilings or at least a profiling with projections and/or recesses at an inside or inside wall of the transport drum. The profiling is thereby provided at least section-wise in the inside of the drum. Such a profiling can for example be provided in the form of a profile projecting inward in a linear shape, spiral shape or helical shape such that it is positioned extending inclined along an inside wall of the transport drum from an inlet side to an outlet side. It is also possible to provide a plurality of combined profilings, for example two spirals entwined with one another, with same spiral direction or helix form in the inside of the transport drum, in order to achieved a controlled movement and pretreatment of the insert elements in the inside of the transport drum through for example a rotation movement of the transport drum. Such a profiled shape of transport means can also be realized by means of profilings formed with recesses or with projecting bar sections in the inside of the transport drum. The profiling or the plurality of profilings in the transport drum can have different shapes of cross-sections, according to the intended burr (degree?) or strength of the pretreatment provided by means of a kind of slide grinding of the surfaces of the insert elements: for example, profilings with semicircular cross-section, trapezoid or triangular profilings or also profilings with a freeform cross-section can be provided in the form of projecting sections in helix shape or spiral shape in the inside of the transport drum. The profilings can also vary as to the incline, in order to cause a slower or quicker conveying onward in different areas. The person skilled in the art is familiar with a large variety of different forms and kinds of such profilings, which can be used for a conveying of the insert elements and at the same time a pretreatment in the inside of the transport drum according to the invention for the purposes of the present invention.

According to a further advantageous embodiment of the invention, at an outer side of the transport drum a suctioning unit, preferably driven by means of vacuum or negative pressure, is provided for the discharging of dirt, particles or fragments from the pretreatment of the insert elements out of the bores or through-holes of the transport drum. Such a suctioning unit, which for example can be provided below or laterally of and below the transport drums, has the advantage that by means of the through-holes or bores, the dirt particles, fragments or dust residues are actively suctioned off from the insert elements treated as bulk material and can be discarded. The insert elements at the outlet of the transport drum, which are then conveyed onward into the storage container, therefore have a high degree of cleanness and of a good dimensional accuracy due to the pretreatment by means of a kind of slide grinding or swirling and striking against one another in the inside of the transport drum, and can be introduced into the storage container as 100% good parts and effectively used in subsequent processes of a fitting of pipette tips.

According to a further advantageous embodiment of the invention, at an outside of the transport drum a pressure generation means is provided, in order to additionally impinge the insert elements with compressed air from below or from a side, through the bores or through-holes of the transport drum during the pretreatment. By means of this measure, a still stronger mixing and swirling of the insert elements is achieved, so that, even with relatively short transport drums and a shortened dwell time in the inside of the transport drum, an improved pretreatment is achieved. The deburring and isolating of insert elements adhering to one another can therefore be actively accelerated and supported from the outside.

According to a further advantageous embodiment of the invention, at an inside of the transport drum at least one profiling is provided in the form of a helix-shaped spiral, preferably a helix-shaped double spiral or multi-helix. Even with a single helix-shaped or helical spiral, which extends at an inside wall of the transport drum and which for example can be provided as a semicircular projecting cross-sectional profile or protrusion in the material of the transport drum, an active conveying onwards is achieved with at the same time pretreatment due to the projecting or protruding profile of the spiral. With an increased number of for example a double spiral or multi-helix, this measure can be further intensified. The sufficient pretreatment can therefore also be achieved with a reduced rotation movement or a shortened shape of such transport drums with a high quality end-result, that is, insert elements deburred with regard to their outer dimensions and optimized in diameter. Also in this way, the conveying onward of the insert elements and their pretreatment becomes possible in the case of a transport drum merely orientated in a horizontal, without for example an extra inclining means or tilting device being required for this.

According to a further advantageous embodiment of the device according to the invention, at an inside of the transport drum a spiral-shaped profiling with constant or variable incline is provided, which has a semicircular trapezoid or triangular projecting profile in cross section. Such a projecting profile can be manufactured by means of stamping of for example a sheet material or perforated sheet by means of pressing or stamping. The projecting profiling can alternatively also be produced by the applying of a wire structure shaped correspondingly in cross-section. In comparison to a trapezoid or triangular shape, a semicircular cross-sectional shape has less influence on the deburring or abrading of the surfaces of the insert elements, whereas the triangular or trapezoid shape realizes a stronger grinding process in the pretreatment due to the edges.

According to a further advantageous embodiment of the invention, the transport drum is a perforated sheet with circular openings or bores or with rectangular through-holes, which is manufactured from a cylindrical sheet element which is bent into a circle and a drum and is open at both ends. Alternatively, the drum can also be formed as a bent polygon, for example hexagonal. With such a perforated sheet or a transport drum manufactured from a sheet material, an effective shape for the purposes of the conveying and the pretreatment of the insert elements in the transport drum in a combined way can be easily realized. Alternatively, the transport drum can also be realized from a wire mesh with a clear mesh size or another such element with through-holes or openings—also of synthetic material—in which the mesh size or the openings are formed correspondingly smaller than the outer diameter or the outer geometry of the insert elements themselves, in order to realize the transport and the conveying onward with combined pretreatment of the insert elements in the transport drum.

According to a further advantageous embodiment of the invention, for generating an at least partly rotation movement of the transport drum a variable drive with a control unit is provided, by means of which the transport drum can be displaced into a rotation movement continuously constant and can also be moved alternatingly, for example in a right-left run. Alternatively, hereabove the transport drum can also be actuated combined with an intermediate stopping or halting of the rotation movement, in order to realize the two combined steps of the transport and the pretreatment by means of a kind of slide grinding in the inside of the transport drum according to the invention. The drive of the transport drum is preferably mounted at the transport drum and connected with the axis X of the transport drum such that the inlet side and the outlet side allow a large enough opening for the introducing and removing of the insert elements as bulk material from an upstream bunker or the like.

According to a further advantageous embodiment of the invention, a storage container provided at the outlet of the transport drum is provided with an automatic fill level detection by means of a fill level sensor or the like. The process of the transport and the pretreatment of the insert elements in the transport drum can therefore be actively regulated and controlled with the device corresponding to the requirement for cleaned and pretreated insert elements in subsequent processes. In the case of a sufficiently filled storage container at the outlet side of the transport drum, a signal is transmitted via the control and from the fill level detection back to the system, so that the conveying onward and pretreatment of new insert elements can be intermittently stopped or decelerated. In this way, a fully automatic handling of such insert elements in the step of the pretreatment is possible by means of the transport drum with the fill level sensor at the storage container. A fill level sensor can for example be provided in the form of an optical sensor above a storage container open at the top. Alternatively, a fill level sensor can also be realized in the form of a sensor element mounted laterally at the storage container or by means of a sensor unit by means of which the current fill weight of the storage container can be detected.

According to an advantageous embodiment of the device according to the invention, the transport drum is provided with means for discharging the insert elements after the pretreatment, with which the finished pretreated insert elements can be taken out of the transport drum and conveyed onwards. For the discharging of the insert elements, means can be provided in particular in the form of an outlet opening of the transport drum itself at the outlet end thereof, a door, or a control for the reversal in rotation direction or change in the tilt angle α of the axis X of the transport drum. With an outlet opening at the outlet end, the taking out of the insert elements can take place by means of gravity, for example through a tilt displacement. Radial openings and also openings facing in axial direction are possible. Alternatively, a door to be actively opened can also be provided at the transport drum itself. Also, doors or rotation direction controls of the transport drum can be provided such that, in the case of a change of the rotation direction, the ready pretreated insert elements are automatically taken out of the transport drum. According to an aspect of the invention with regard to this, an outlet opening at the end of the transport drum for the emptying of the insert elements can be formed such that, in the case of a forward movement of the transport drum, the discharge opening remains closed by means of a kind of roof profile, and in the case of a backward movement, the opening at the outlet end of the transport drum for the emptying is opened. This kind of a closing-/opening mechanism is for example also known as so-called “Lotto-Drum”, in which the outlet opening is quasi positioned in the rotational shadow.

According to a further advantageous embodiment of the device according to the invention, between an outlet of the transport drum and before the storage container of the device, a mean for the sorting out of reject parts in relation to good parts of the insert elements is provided, in particular in the form of a pneumatic suctioning off, a slider, an ejector and/or a push-through unit with regard to the bores or openings in the sieve plate. With a for example pneumatic suctioning off, as likewise for the mechanical means for sorting out of reject parts, the distinguishing and discharging of reject parts and good parts between the transport drum and the predetermined storage container can be effectively carried out. Therefore, at the end, only good parts reach the storage container, so that the reject parts or broken-off insert elements can be discharged from the process beforehand. In this connection, it is also possible to effect a sorting-out means in the form that an area of the device, for example the sieve plate, is moved out laterally from the area of the storage container by means of a displacement unit. Alternatively, also a displacement movement of the sieve plate itself can be effected, in order to realize such a sorting-out of reject parts with the device according to the invention. In all these variants, it is likewise possible to temporarily halt a further supply of insert elements from the transport drum by means of a closable bulkhead. Also, combinations of the described pneumatic or mechanical means for the sorting out of reject parts can be used at this place in the device according to the invention.

According to a further advantageous embodiment of the device according to the invention, a detection means for the recognition of reject parts of insert elements is provided after the transport drum in the conveying direction with regard to the insert elements. Such a detection means can be a sensor, for example an optical sensor. Also, camera-based detection means can be used. Alternatively, it is also possible to use so-called pre-sorting screens, by means of which the good parts are detected from the bad parts and can be moved out of the process in corresponding different conveying directions.

According to a further advantageous embodiment of the invention, a means for the sorting out of undersized parts of the insert elements is provided which in at least one dimension are below a predetermined tolerance size of the insert elements, in the form of a sieve screen with sieve openings dimensioned corresponding to the tolerance size. The insert elements pretreated in the transport drum and correspondingly processed, are therefore subsequently also put through a sorting means in the form of a sieve screen, which is provided with openings in the sieve such that in a determined dimension like for example width or diameter, too small insert elements are sieved out and only the so-called good parts as being within the tolerance with dimensions in the tolerance range are conveyed on. The means for the sorting out have a kind of sieve screen or hole-grid with sieve openings and hole sizes in the form that, for example, the diameter of cylindrical insert elements has a minimum size for a holding above the sieve screen. The insert elements which have less than this minimum size fall through the sieve openings or holes and can be correspondingly discharged from the process as so-called bad parts. In this way, the manufactured and pretreated insert elements as end products can be improved still further as to quality and dimensional conformity. Also, those parts from which burrs or unintended projecting elements were processed off in the pretreatment in the transport drum, but which then do not have the minimum size anymore, are therefore securely and simply sorted out through the sieve screen before a conveying onward into the containers for good parts or into a downstream process of an automatized assembling in pipette tips or the like. The amount of waste or bad parts in the end products is therefore clearly further reduced.

According to a further advantageous embodiment of the invention with regard to this, the device is provided with a means for the sorting out of undersized parts of the insert elements in the form of a sieve screen, which is provided at least section-wise with an incline in relation to the horizontal and in particular is arranged above a container for reject parts. The sieve screen for the filtering out of undersized parts is therefore arranged in a kind of incline or tilt in relation to the horizontal, for example above a collection container or a conveyor belt. In this way, after a sieving out, the reject parts fall simply due to gravity out through the sieve openings of the sieve screen, and the good parts remain above the tiltedly oriented sieve screen. They can then subsequently be collected in a further container for good parts or be conveyed in a downstream process on a conveyor belt or the like directly for the further use and in particular for the inserting into the injection-molded parts. The means for the separating out of undersized parts are therefore relatively simply structurally assembled and have a high degree of efficiency. The separation of good parts from bad parts therefore takes place in a downstream, further device part after the pretreatment of the insert elements inside the transport drums. According to a further aspect of the invention in this regard, the sieve plate can also be provided as a tumbling plate with a shaking motion. This increases the speed and efficiency still further during the sorting out of such undersized parts having less than a predetermined lower dimension of the tolerance range of such insert elements.

Further features, aspects and advantages of the present invention are described in more detail in the following by means of different embodiments of the invention with regard to the attached drawings and the Figures included therein, wherein

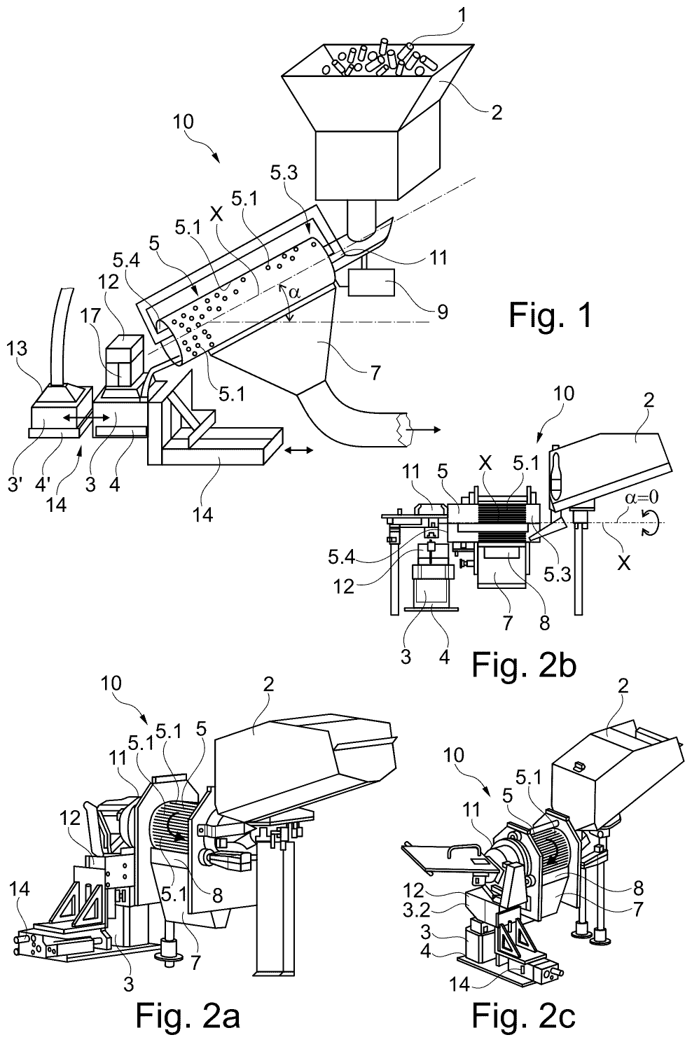

FIG. 1 shows a schematic perspective view of a first embodiment of a device according to the invention for the pretreatment and transport of filter elements for pipette tips;

FIG. 2a to FIG. 2c show different views of a second embodiment of a device according to the invention for the pretreatment of filter elements for pipette tips with two perspective views (FIG. 2a, FIG. 2c) and a top view (FIG. 2b);

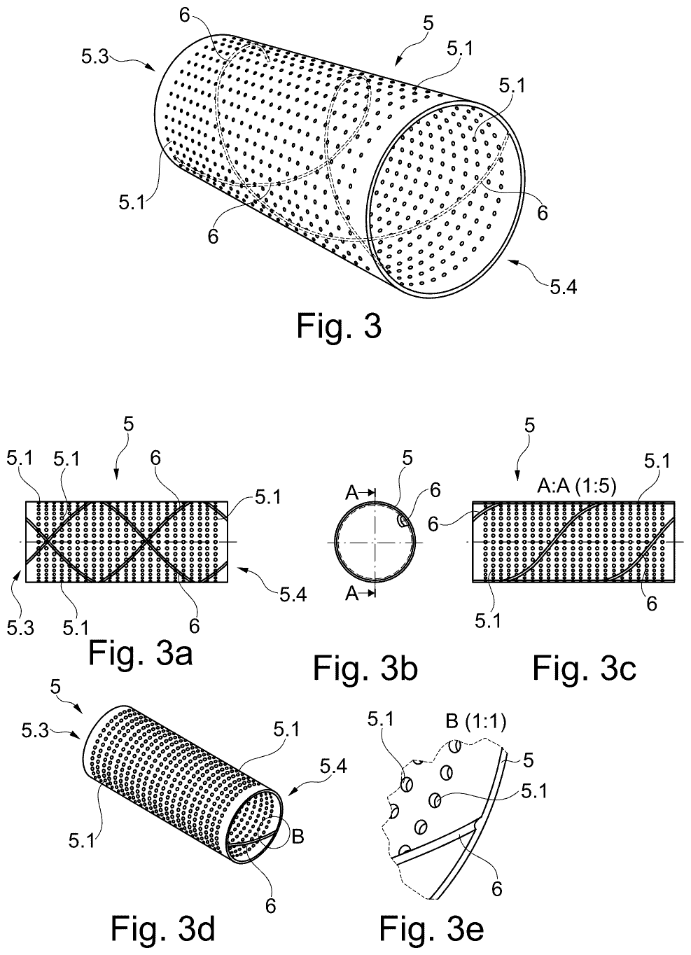

FIG. 3 to FIG. 3d show different views of an embodiment of a transport drum according to the invention for a device for the pretreatment and transport of filter elements with perspective views (FIG. 3, FIG. 3d), a top view (FIG. 3a), a lateral view (FIG. 3b) and a sectional view according to A-A (FIG. 3c);

and

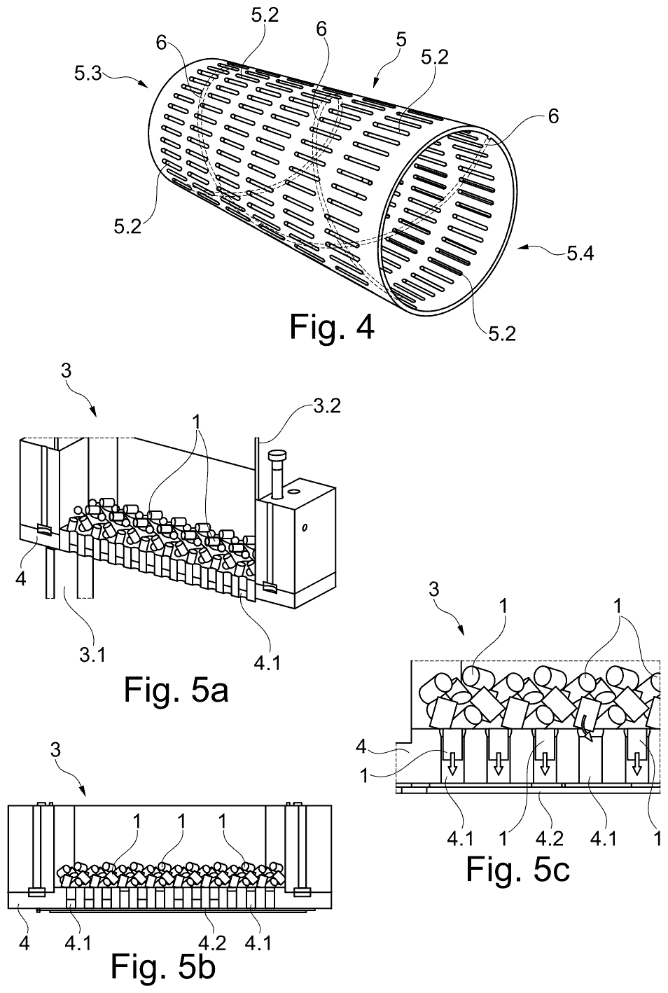

FIG. 4 shows an alternative embodiment of a transport drum for use in an embodiment of a device and method according to the invention in a perspective view with slot-shaped through-holes, instead of bores and round openings;

FIG. 5a to FIG. 5c show different detailed views of a storage container according to an embodiment of the device according to the invention for the receiving and sorting of filter elements pretreated in the transport drum;

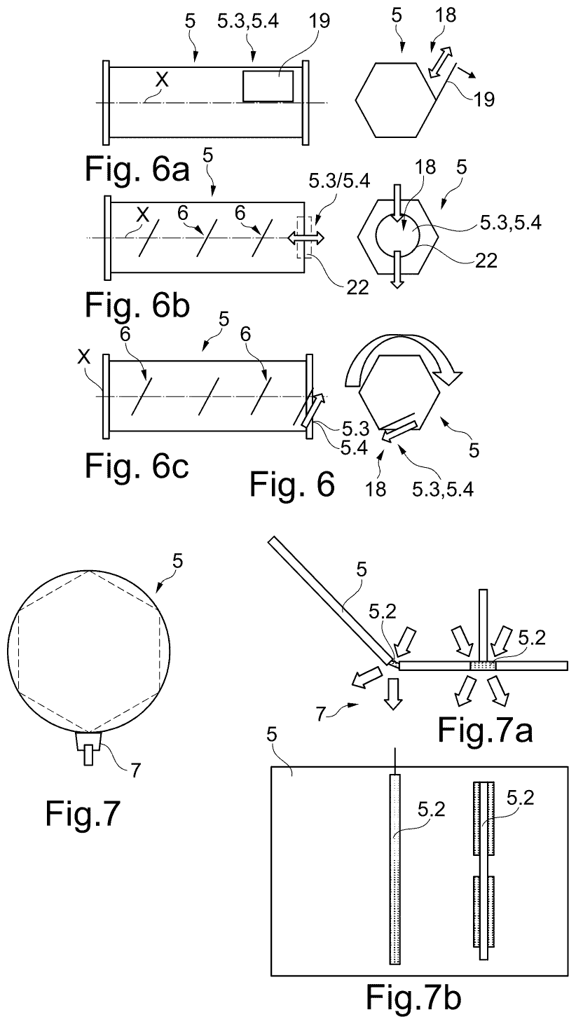

FIG. 6 shows three schematic views (top view and cross-section) of variants for a transport drum according to the invention of a pretreatment device for filter elements with different possibilities of a placing in, or a taking out, of the insert elements into or out of the transport drum with, in FIG. 6a, a radial opening in the form of a door, in FIG. 6b an axial opening in the form of a support, and in FIG. 6c, a taking out by means of a reversal of rotation direction;

FIG. 7, FIG. 7a and FIG. 7b show different schematic views of an embodiment of the device according to the invention for the pretreatment of filter elements with an angular cross-sectional shape of the transport drum and suction unit provided at different openings;

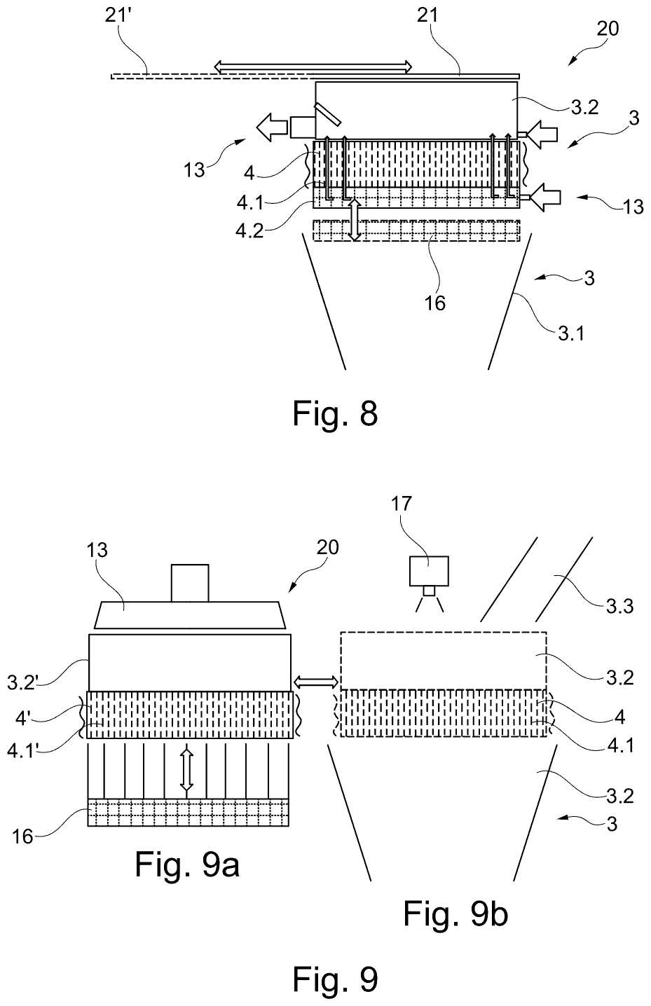

FIG. 8 shows a schematic lateral view of an embodiment of a shape of a sorting unit for bad parts of the device according to the invention with lateral suctioning-off;

FIG. 9, FIG. 9a and FIG. 9b show schematic views of a further embodiment of a sorting unit of bad parts according to the invention for the pretreatment of insert parts with a suction unit 13 and lateral displacement possibilities of the sieve plate to an ejector,

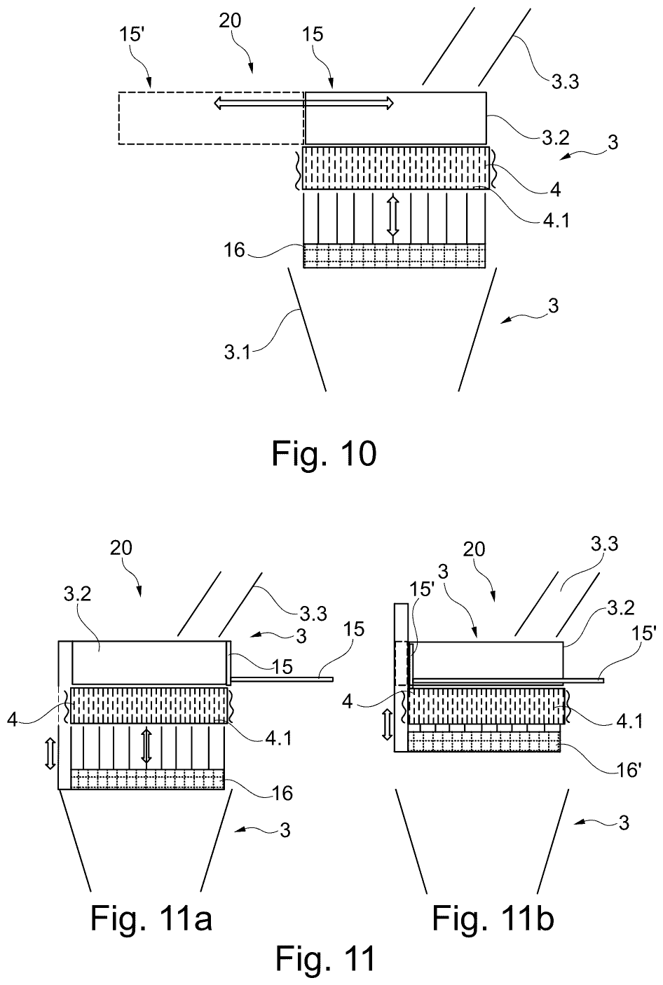

FIG. 10 shows a schematic lateral view of a further embodiment of a sorting unit according to the invention for bad parts from the device for the pretreatment of the insert elements with a displaceable funnel before the sieve plate of the storage container;

FIG. 11, FIG. 11a and FIG. 11b show schematic lateral views of further embodiments of a sorting unit according to the invention for bad parts at the storage container of the device for the pretreatment of the insert elements;

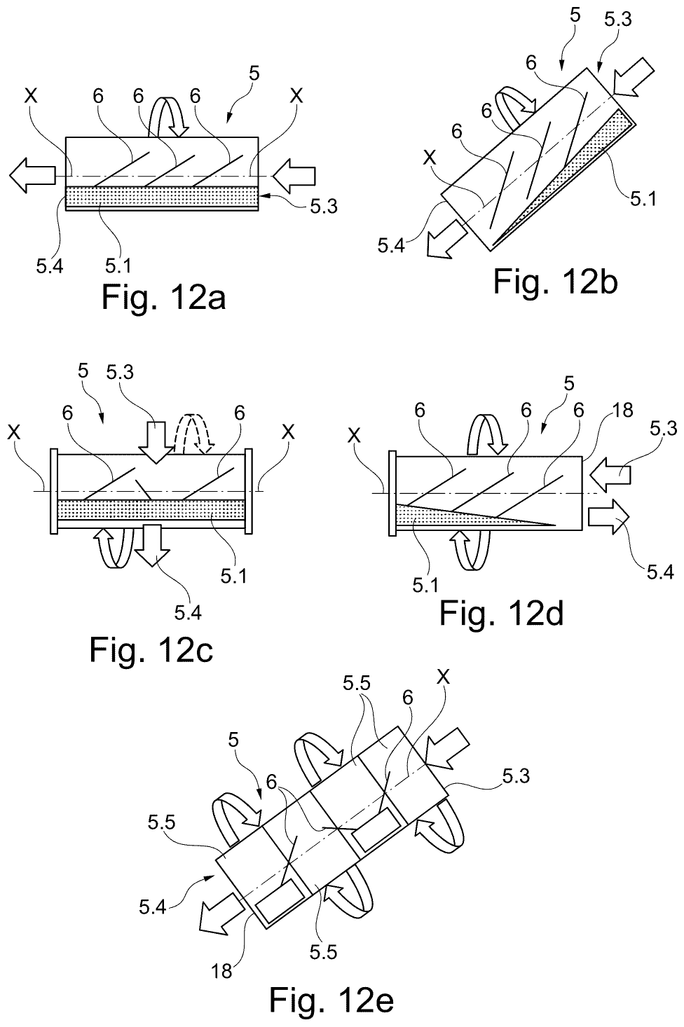

FIG. 12a to FIG. 12e show different variants in schematic lateral views for different operation modes of the transport drum for the pretreatment of the insert elements according to the invention;

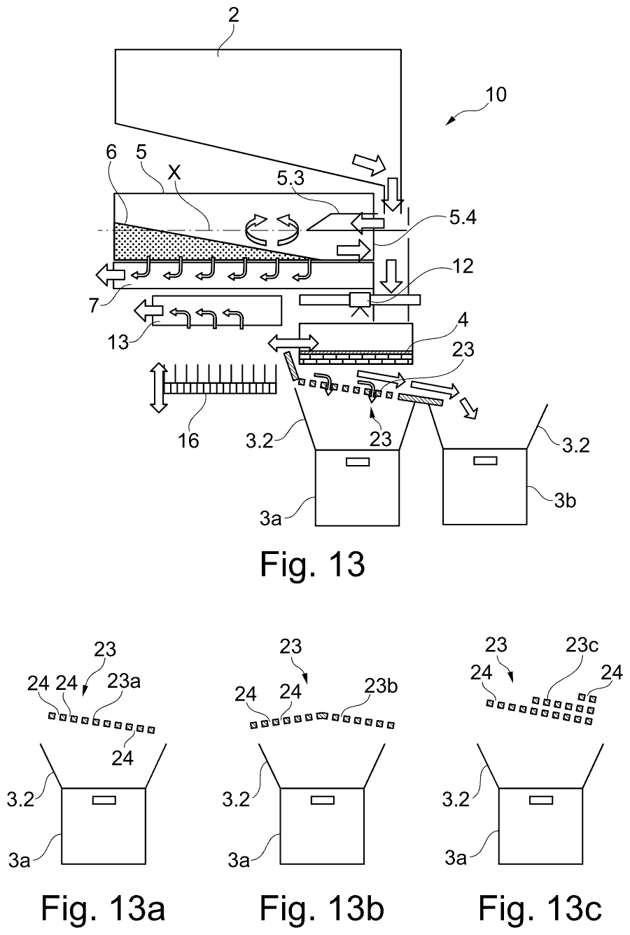

FIG. 13 shows a schematic lateral view of a further embodiment of a device according to the invention for the pretreatment and transport of insert elements for injection molded parts with a downstream discharging of undersized parts; and

FIG. 13a, FIG. 13b and FIG. 13c show different detailed views of variants of a sieve screen for a sorting out of undersized parts in the embodiment of a device for the treating of insert elements according to FIG. 13.

The FIG. 1 of the drawings shows a first embodiment of a device 10 according to the invention for the pretreatment and the transport of insert elements like for example cylindrical filter elements 1 for the fitting of injection-molded parts like pipette tips, which are supplied in the form of bulk material into a supply container 2, which in this embodiment is realized as a funnel-shaped bunker open and widened toward the top. The filter elements 1 are subsequently provided from the supply container 2 via a transport drum 5 with bores or openings 5.1 via the entrance 5.3 thereof, which have a smaller dimension or other shape than the diameter or the cross-sectional shape of the filter elements 1, wherein the transport drum 5 is mounted rotatably about a rotational axis X.

The transport drum 5 serves for the transporting and also for the pretreating of the filter elements 1, in particular by means of a kind of surface treatment termed slide grinding, in order to remove possible burrs from the edges or molding flaws, or to isolate filter elements 1 adhering together in the inside of the transport drum 5. For this, the transport drum 5 is rotatably driven about the main axis X and, in this embodiment, provided in its inside with corresponding settings and means for the pretreatment. The means for the pretreatment can be a profiling 6 or simply a shape of the wall of the drum 5, like for example a polygonal cross-sectional shape. For this, at the rotational axis X of the transport drum 5, a drive motor 11 is provided which, by means of a control unit 9, can be actuated corresponding to an intended length of the pretreatment and dwell time of the filter elements 1 in the transport drum 5. The transport drum 5 in this embodiment has a cylindrical shape and is formed with a plurality of openings 5.1 or bores of same type and same shape in the material, for example a metal sheet. The transport drum 5 can alternatively also have a polygonal cross-sectional shape, instead of a round cylindrical one. Further, in this embodiment the transport drum 5 is positioned inclined in a slightly tilted orientation in relation to the horizontal, at an angle of inclination α. The filter elements 1 supplied from the supply container 2 or bunker are therefore treated at their surface in the pretreatment step in the transport drum 5 by means of an at least intermittent rotation movement of the transport drum 5 together with a transporting in combination with gravity, so that after discharging cleaned and deburred at a lower outlet end 5.4 of the transport drum 5 they are able to be re-used according to the invention, in particular in a fitting process of pipette tips.

While the filter elements 1 are in the inside of the transport drum 5, it is set in rotational movement at least intermittently by means of the drive motor via the control unit 9, in either one direction or alternatingly in a forwards- and backwards direction, so that the filter elements 1 in the inside of the transport drum 5 strike one another and strike against the insides of the transport drum 5. In this way, the burrs at the edges or other projections sometimes found at the filter elements 1 are completely removed and, in the case of collating together, the filter elements 1 are also isolated from one another. The openings 5.1 or bores in the cylindrical jacket wall of the transport drum 5 in this embodiment are circular openings 5.1. According to the invention, the openings 5.1 have a smaller diameter than the outer diameter of the filter elements 1, which are likewise cylindrical in this embodiment, so that the filter elements 1 remain in the inside of the transport drum 5, but splintered-off material parts, fragments or dirt particles are discharged effectively from the transport drum 5 by means of the openings 5.1. During the pretreatment of the filter elements 1 in the transport drum 5, therefore, in particular also by means of the rotation movement and preferably the inclination or tilted position at the angle α of the axis X of the drum 5, on the one hand the filter elements 1 are moved from an inlet 5.3 on the side of the supply container 2 to an outlet 5.4 in the direction of the storage container 3 and at the same time, thereby in one step, pretreated by means of the abrading against one another of the individual filter elements 1 and an abrading at an inside wall of the transport drum 5.

The inside wall of the transport drum 5 can for example also be provided with a profiling 6 projecting inwards or recessed on the inside along the longitudinal direction of the axis X, by means of which this pretreatment of the filter elements 1 can take place further improved by the removal of wrong shapes like burrs or the like effectively in the length of time (dwell time) in the transport drum 5 of the filter elements 1. After the removal of the burrs, residual particles, fragments, or of the material dust from the openings 5.1 of the drum 5, the filter elements 1 subsequently at the outlet 5.4 of the drum 5 reach a storage container 3 in a cleaned, intended shape with the predetermined dimensional accuracy as good parts. The storage container 3 in this embodiment is provided with a bottom formed as a sieve plate 4, which has a series of openings 4.1 corresponding to the outer diameter of the filter elements 1, into which these are inserted by means of a kind of shaking motion into the individual bores 4.1, in order to automatically prepare them for the further processing (compare here also FIG. 5a to FIG. 5c). Thus only filter elements 1 are discharged from the transport drum 5 which are prepared with regard to dimensional accuracy and quality and shape such that, during the further processing, they do not lead to unintended down times of the mostly automatized handling of such filter elements 1 or to increased rejects. In the first embodiment shown in FIG. 1, a suction unit 7 is provided at a lower side of the transport drum 5 which securely removes particulate parts and dirt particles emerging from the openings 5.1 of the transport drum 5, by means of a low pressure or vacuum, before the filter elements 1 are then poured out into the storage container 3.

Further in this embodiment, at the storage container 3 there is also a filling level sensor 12, by means of which the control of the dwell time in the transport drum 5 or the supplying of filter elements 1 from the supply container 2 can be controlled by means of the control unit 9 corresponding to the requirement in the further processing of filter elements 1. For this, the control unit 9 is formed such that on one side the angle of inclination α of the transport drum 5, a rotation movement about the axis X of the transport drum 5 or also the supplying of filter elements 1 from the supply container 2 corresponding to the intended dwell time and the intended number of filter elements 1 to be handled in the fitting process of the pipette tips can be automatically controlled.

In the embodiment of FIG. 1, a displacement unit 14 is also shown adjacent to the storage container 3, by means of which for example by means of a handling system or of a transfer plate and buffer plate, the individual, cleaned and pretreated filter elements 1 can be removed from the sieve plate 4 of the storage container 3 and further processed. On the left of the storage container 3, a cleaning unit 13 is shown, by means of which the filter elements 1 located in the storage container 3 are further cleaned and rejects are discharged. In this cleaning unit 13, a filter extraction with a suction unit going upward is integrated. When the storage container 3 is in a laterally displaced position (reference numerals 3′, 4′) as indicated by the arrow in FIG. 1, by means of the filter extraction of the cleaning unit 13 a removal of bad parts upwards can be carried out, so that only good parts remain in the container 3 and the sieve plate 4. The transport drum 5 according to this embodiment has a circular cylindrical form with completely open inlet- and outlet end 5.3, 5.4, and can for example be provided from a perforated sheet with same-shape round openings 5.1 or bores and manufactured from a curved and joined together sheet. Alternative shapes of not-round openings 5.1 are imaginable, as are a partly closed outlet end 5.4 or polygonal, for example hexagonal, cross sections of the transport drum 5.

At the inside of the transport drum 5, a profiling 6 can be provided or not according to the further embodiments described below. Such a profiling 6 can for example be a spiral-shaped profiling 6 projecting inward with a predetermined cross section. The transport drum 5 can also be realized with other means for the conveying onward of the filter elements 1 in the process of the pretreatment in the transport drum 5, for example with pneumatic actuators or nozzles for the further transport and/or for the swirling of the filter elements 1 in the inside of the transport drum. Also in this way together with the control unit 9, the average intended dwell time and thus length of time of the pretreatment in the transport drum 5 can be variably adjusted according to the invention.

With the device 10 formed in this way for the pretreatment and the conveying of filter elements 1 in a fitting process of injection molded parts, like for example pipette tips, a fully automatic handling of the fitting can be further optimized. The filter elements 1 coming from the pretreatment in the device 10 according to the invention are clearly better regarding dimensional accuracy and quality than in previous such systems. The down times and the rejection of filter elements 1 found to be not good can be clearly reduced. Therefore a considerable increase in filter quality and increase in the degree of efficiency of such a filter assembly line in automatized systems is achieved. The filter elements 1 do not have any protruding burrs at their edges anymore, when they come out of the pretreatment step according to the method of the invention in the device 10 and its transport drum 5. Also in this way, an isolating of filter elements 1 adhered together (so-called double filters) can be effectively carried out also at the profilings 6 by means of the abrading against one another and sliding of the filter elements 1 in the inside of the transport drum 5. The broken-off pieces, material dust, micro-fragments and fragmented filters etc. caused hereby can preferably be automatically discharged from the process and from the transport drum 5 directly or in the described subsequent separation step in the cleaning unit 13. In as far as they do not come out of the bores or openings 5.1 by themselves or with vacuum support, they can also be brought out at an outlet 5.4 of a transport drum 5 which is positioned tilted, by means of corresponding devices and units 13, before an entering into the storage container 3. The invention therefore has the considerable technical advantage that a discharging of not dimensionally accurate filters and filter elements 1 is therefore made possible and a high number of filter elements 1, found to be good with regard to dimensional accuracy, is produced at the outcome of the pretreatment steps.

The FIGS. 2a, 2b and 2c show in different views a second embodiment of a device 10 according to the invention for the pretreatment and the transporting of filter elements 1 in a fitting process of pipette tips or the like. In this second embodiment, the transport drum 5 is oriented without an inclined position in a horizontal direction according to its axis of rotation X, that is, at an angle α=0 (angle of inclination α=0°). The supply container 2 is here not formed as a filling funnel open at the top for the filter elements 1 provided as bulk material, but as a closed box or bunker oriented inclined. Also in this embodiment of the FIGS. 2a to 2c, in the transport drum 5 which is rotatably movable about an axis X there are openings 5.1 and bores which are different in shape from or smaller in diameter than the outer diameter and outer geometry of the filter elements 1, so that in the pretreatment step the filter elements 1 remain in the inside of the transport drum 5, while abraded material, particles, broken-off parts or dust particles can be discharged from the process by a suction unit 7 or the like via the openings 5.1 of the transport drum 5 effectively just by means of gravity. Also in this embodiment, in the inside of the transport drum 5, different means for the transport and the conveying of the filter elements 1 from an inlet side from the supply container 2 to an outlet side of the transport drum 5 can be provided, which are preferably realized in the form of one (or a plurality of) helical or spiral-shaped profiling(s) 6 (not shown, compare FIG. 3, FIG. 4). Therefore, during a rotating of the transport drum 5 about the axis X by means of the drive motor 11 by means of the control unit 9, the filter elements 1 are displaced with force against one another in the transport drum 5 and at the walls and at the projecting profilings 6 in the transport drum 5 and treated in a kind of slide grinding. Thereby, possibly protruding burrs at the edges are removed and the filter elements 1 improved in this way with regard to dimensional accuracy are provided for a further handling in the preferably automatized fitting process of pipette tips in a downstream storage container 3 (compare also, for example, embodiment of the storage container 3 according to FIGS. 5a to 5c).

Here too, the storage container 3 is realized with a filling level sensor 12, by means of which according to a control 9 the current filling level and the requirement for filter elements 1 to be pretreated is detected and the pretreatment steps in the transport drum 5 are controlled. Here too, a handling system and a displacement unit 14 are positioned at the storage container 3, by means of which the filter elements 1 then to be further used can be transported into the fitting process. Also in this second embodiment of FIG. 2a to FIG. 2c, a means for the changing of an angle of inclination α of the transport drum 5 in relation to the horizontal can be provided. However, this is only optional; it is not necessary for the realization of the invention. In this embodiment, as also in the before-mentioned first embodiment, a suction unit 7 is positioned at a lower side of the transport drum 5. Here, by means of an underpressure the removal of material particles from the openings 5.1 of the transport drum 5 is improved and accelerated, and the filter elements 1 cleaned in the pretreatment step therefore reach the downstream storage container 3 with the sieve plate 4 without interfering residual particles or broken-off parts.

In addition and in contrast to the first embodiment of FIG. 1, in this second embodiment there is also a pressure generating means 8 at a lower side of the transport drum 5. By means of this pressure generating unit 8, a specifically-directed further swirling and mixing together of the filter elements 1 to be pretreated in the inside of the transport drum 5 can be caused. The compressed air introduced via the openings 5.1 increases the throughput rate and the speed of the treatment in the transport drum 5, so that a shorter dwell time during the pretreatment is made possible.

In FIG. 3, in a perspective detailed view, an embodiment of a transport drum 5 according to the invention for use in a method and a device 10 according to the present invention is shown. According to FIG. 3, the transport drum 5 here too is a cylindrical round structure in the form of a kind of perforated sheet with an evenly arranged series of openings 5.1 or bores. The openings 5.1 have a smaller diameter than the outer diameter of the cylindrical filter elements 1 to be treated, so that these remain in the step of the pretreatment and of the further transporting in the transport drum 5, while broken-off parts, material particles, dirt particles etc. can be discharged from the process automatically according to the invention. In the embodiment of a transport drum 5 according to the invention shown in FIG. 3 and in top views (FIG. 3a, FIG. 3b) of a sectional representation according to FIG. 3c and the detailed view according to FIG. 3e from FIG. 3d (perspective view), a profiling 6 is provided in the inside at an inner side of the transport drum 5. The profiling 6 is here formed as a kind of double helix with a helical profile protruding inward (see FIG. 3e). The spiral-shaped profiling 6 here has a semicircular profile in cross-section, as can be seen from the detailed view of FIG. 3e.

The helix or profiling 6 has the advantage that during a rotation movement of the transport drum 5, the filter elements 1 for one thing strike against one another and for another, strike the protruding profiling 6, so that the degree of cleaning and the degree of pretreatment in a kind of contact grinding are therefore improved. At the same time, the profiling functions as a helix in the manner of a screw conveyor and brings about the transporting from the inlet 5.3 to the outlet 5.4 The profiling 6 can also have a different cross-section than a semicircular cross-section, for example a triangular-shaped, trapezoid-shaped cross-section or one formed in a free shape, according to which strength of the pretreatment is to be generated. The helical profiling 6 shown here has a smooth gradient, but can also be varied with an increasing or decreasing gradient and be provided with an increased or reduced number of windings. The profiling 6 can be provided as individual helical or screw-shaped spiral or as a multiple helix having more than two spirals. The transport drum 5 can for example be realized from a prefabricated perforated sheet by means of a bending and welding together of a prefabricated perforated sheet. It is also possible to realize other shapes of transport drum 5, in which the respective openings 5.1 or through-holes 5.2 have a different cross-sectional shape than a round one. It is also thinkable to produce such transport drums 5 from a wire mesh with a smaller mesh opening than the diameter of the filter elements 1 or as plastic drum with openings. All of these elements of a possible embodiment of the transport drum 5 have in common that the filter elements 1 located in the rotation movement about the axis X and in the transporting through the transport drum 5, are at the same time pretreated during transport by means of a spalling (breaking-off) or removal of protruding burrs or the like, an isolating of filter elements 1 adhering together, and a discharging and removing from the subsequent process of interfering particles or bad parts by means of, for example, a suction unit 7 or a downstream cleaning unit 13 or simply by gravity, out from the openings 5.1 and 5.2.

In the further embodiment of a transport drum 5, as a detail of the device 10 according to the invention according to FIG. 4, a transport drum 5 is shown in which slot-shaped through-holes 5.2 are provided in contrast to the circular bores or openings 5.1 of the before-mentioned embodiments. Also the slot-shaped through-holes 5.2 have a smaller diameter or width than those of the filter elements 1, so that the pretreatment and discharging of the dirt particles and a high quality of the filter elements 1 thus conveyed onward can be achieved. Also in this embodiment of the FIG. 4, a profiling 6 in the form of a double helix is shown with a profile projecting inward. Alternatively, a profiling 6 realized as a recess or a different form than a spiral-shaped profiling 6 can also be provided, for example individual projecting ridges in the inside of the transport drum 5 in the form of guide vanes or the like.

In all of the embodiments according to the invention, a drive 11 of the transport drum 5 and a control unit 9 can be provided such that a continuous rotation movement or an interrupted rotation movement about an axis X can be provided. The control unit 9, which was described above, can be formed such that the rotation movement can, according to requirement, be generated or interrupted at filter elements 1 to be pretreated. Therefore, an interrupting and intermittent stopping of the rotation movement about the axis X of the transport drum 5 is also realizable, in order for example to increase the mixing together and the speed of the pretreatment of the filter elements 1.

The FIGS. 5a, 5b and 5c show detailed views of a storage container 3, which is provided as described above in the device 10 of the invention of the transport drum 5. In the storage container 3 (see also FIG. 1 to FIG. 2c) the cleaned filter elements 1, pretreated and optimized as to dimensional accuracy, are taken up as good parts from an outlet side 5.4 of the transport drum 5 and inserted by means of a shaking motion into openings or bores 4.1 provided for this, in a sieve plate 4 (see enlarged view, FIG. 5c). For this, the through-holes 4.1 of the sieve plate 4 have an upper funnel-shaped widened inlet and are somewhat longer in length than the length of the filter elements 1. Below the sieve plate 4, which forms the bottom of the storage container 3, a retaining means 4.2 can be provided in the form of a buffer plate of a bulkhead or a transfer plate. The filter elements 1, then supplied in this way ordered and cleaned, can be removed via the transfer plate from the storage container 3 according to requirement as 100% good parts, and further processed automatically via a (not shown) handling system. Alternatively to such a storage container 3, the filter elements 1 coming from the transport- and pretreatment drum 5 can also be used as bulk material in another storage container 3 for storage-holding and supplying for subsequent automatized or also manual processes of the fitting of pipette tips or the like with filter elements 1.

In FIG. 6 and in corresponding front views and cross-sectional views of FIG. 6a, FIG. 6b and FIG. 6c, a plurality of alternative embodiments are shown for the form of a transport drum 5 for use in the device 10 according to the invention with different possibilities of introducing and removing of filter elements 1 via the inlets 5.3 and the outlets 5.4 and outlet opening 18. In these embodiments of FIG. 6, the transport drum 5 is realized in its cross-section as a polygonal drum structure instead of a circular round cylindrical transport drum 5 as in the previous embodiments. Instead of a transport drum 5 open on both sides with an inlet 5.3 and an outlet 5.4, here in FIG. 6a the drum is laterally closed, and the inlet/outlet 5.3, 5.4 is realized in the form of a radial opening for example as a door 19, by means of which the filter elements 1 are introduced into and after the step of the pretreatment taken out again from the transport drum 5. A further alternative for a placing in and taking out of the filter elements 1 into and from the transport drum 5 is shown in FIG. 6b in corresponding lateral view and cross-sectional representation. Here, the transport drum 5 is completely closed on one side and has at the right-hand end a kind of axial opening of reduced cross-section in relation to the outer diameter of the transport drum 5. In this embodiment, this axial opening is formed in the shape of a support 22, by means of which, as shown by the arrow, the filter elements 1 are introduced and, after the pretreatment by means of the profiling 6 in the inside of the transport drum 5, transported out again. In the further alternative for the placing in or taking out of the filter elements 1 according to FIG. 6c, a radial or axial opening is formed in a rotational shadow such that, by means of the reversal of direction of rotation of the rotation of the transport drum 5 about the axis X, as indicated by the arrow, an opening or a closing of the opening serving as both inlet 5.3 and outlet 5.4 takes place. During a rotation about the axis X in clockwise direction, the filter elements are transported out of the inside of the transport drum 5, as indicated in FIG. 6c by the arrows, while during rotation in the opposite direction in anti-clockwise direction, the filter elements 1 remain in the transport drum 5 for the determined dwell time of the pretreatment by means of the profiling or also without profiling in the way of a slide grinding in the transport drum 5. Alternative forms for the inlets 5.3 and outlets 5.4 of the transport drum 5 can likewise be provided in the scope of the claims of the patent application, which are not additionally represented.

FIG. 7 and FIG. 7a, FIG. 7b show in a cross-sectional view and a partly cross-sectional view and partly top view in each case a further embodiment of the device according to the invention with regard to the suction unit 7 for a removing of particles, dust and dirt particles from the inside of the transport drum 5 during the process of the pretreatment. In the embodiment shown here, the suction unit 7 is arranged at a lower side of the rotatably mounted transport drum 5 and effects a suction by means of underpressure or vacuum for the suctioning out of dirt particles or small parts from the surface treatment step of the filter elements 1 in the inside of the transport drum 5. The transport drum 5 in this embodiment, like for FIG. 6, is realized as a polygonal, for example hexagonal, drum 5, and at the corners of the hexagon there are smaller slots 5.2, while at the straight sections of the transport drum 5 there are larger slots 5.2 approximately in the middle thereof (see FIGS. 7a and 7b). In this way, different effects can be achieved with regard to the dusting-off and cleaning by means of the suction unit 7, as is indicated by the arrows in FIG. 7a.

In a schematic view, FIG. 8 shows a further embodiment of a sorting unit 20 according to the invention for the separating of good parts and bad parts of the filter elements 1, after these have been removed from the transport drum 5 from the outlet 5.4 thereof. By means of a container 21, a funnel 3.2 of the storage container 3 is closed and opened according to requirement (see arrow in FIG. 8). At the funnel 3.2, on the left and right, a cleaning unit 13 functioning by means of compressed air and a suctioning is mounted. The compressed air is supplied below the sieve plate 4 at the storage container 3 on the right, in order to remove, via the openings or through-holes 4.1 of the sieve plate 4 by means of compressed air, jammed filter elements 1 or residue of filter elements, which can then be removed via the filter suction, shown on the left in FIG. 8, of the cleaning unit 13 in the step of the separating and discharging of bad parts. At the lower side of the sieve plate 4, there is also a seal plate as retention means 4.1 in order to allow the discharge of bad parts by the sorting unit 20, taking place laterally by means of the compressed air and supplied air. Subsequently only good parts from the sieve plate 4 then reach the container shaft 3.1 of the storage container 3.

A similar variant with pneumatically functioning sorting unit 20 is represented in the further embodiment in FIG. 9. As before, via a cleaning unit 13 by means of underpressure the bad parts of the filter elements 1 are taken out of the device by suction from the funnel 3.2 and before the sieve plate 4. The filter elements 1 coming from a supply shaft 3.3 are positioned in the storage container 3 at first above the sieve plate 4, wherein only good parts of the filter elements 1 reach the corresponding openings 4.1 of the sieve plate, because they fit into them there due to the shaking. In the step of the discharging of bad parts or the fault clearance of the device 10, 20, in the embodiment of FIG. 9 with a corresponding displacing unit, the sieve plate 4 is displaced to the left together with the funnel 3.2 laterally of the container shaft 3.1 (see arrow in FIG. 9 and reference numerals 4′, 3.2′). The cleaning unit 13 positioned there is provided with a filter suction system, so that the filter elements 1 recognized as bad parts or positioned above the sieve plate 4 can simply be suctioned off. Additionally or alternatively, at a lower side there is also an ejector 16, with which by means of protruding rods or pins the filter elements located in the bores 4.1 of the sieve plate 4′ can be discharged, in order then to be removed by means of the suctioning off by the cleaning unit 13. In order to recognize in the device 10 that reject parts or bad parts are located at the sieve plate 4 of the storage container 3, a bad part sensor 17, for example a camera-based sensor, can be provided. This is aimed at the upwardly open area of the funnel 3.2 of the storage container 3 such that, when recognizing bad parts, the step of a fault clearance or discharging of bad parts, as realizable with the sorting unit 20, is carried out.

In a further schematic lateral view of FIG. 10, an alternative embodiment is shown for a sorting unit 20 in the scope of the device 10 according to the present invention. In this embodiment, the sieve plate 4 is not moved laterally, but merely the funnel 3.2, positioned over it, of the storage container 3 is displaced to the left, as shown by the arrow in FIG. 10, in the step of a sorting, that is, after determining of bad parts of the filter elements 1 at the sieve plate 4. The funnel 3.2 of the storage container therefore serves at the same time as a slider 15, by means of which filter elements 1 located at the surface of the sieve plate 4 which have not entered into the bores 4.1 provided for them due to too large size, burrs or the like, can be laterally displaced out. In order also to make the removal of filter elements positioned in the bores 4.1 possible, here too an optional ejector 16 is shown at the lower side of the sieve plate 4, by means of which the filter elements stuck in the bores 4.1 can be removed upwardly for the discharging from the storage container 3. Therefore, here too, after the treatment in the sorting unit 20, only good parts reach the storage shaft 3.1 of the storage container as filter elements 1 for further use in the process of the fitting of injection-molded parts.

A further alternative form of a sorting unit 20 of the device 10 according to the invention is shown in FIG. 11 and in the detailed views FIG. 11a, FIG. 11b in different states. Here, the filter elements 1 reaching the container 3 via a supply shaft 3.3 are removed from the funnel 3.2 via a slider 15 which can be laterally displaced in. Here too, an ejector 16 can be provided at the lower side of the sieve plate 4 provided with holes or bores 4.1, in order to completely remove stuck filter elements 1 from the sieve plate 4 and thus from the storage container 3. The advantage hereby is that the sieve plate 4, which is realized as a kind of swinging unit for the generation of the shaking motion, is provided as a fixed component art, while only the funnel 3.2 of the storage container is laterally displaced (FIG. 10) and the slide 15 is mechanically actuated in a lateral movement (FIG. 11). Therefore, simple movement sequences for the removing of bad parts from the storage container 3 by means of the sorting unit 20 are possible.

FIG. 12a to FIG. 12e show different possible modes of operation of the device 10 with a drum 5 for the pretreatment of filter elements 1, in order to treat the filter elements 1 in the inside of the transport drum 5 for the surface treatment and, at the same time, to transport them from an inlet 5.3 to an outlet 5.4 or outlet opening after the pre-set dwell time. FIG. 12a and FIG. 12b show a mode of operation of a run from an inlet 5.3 provided on one side to an outlet 5.4 of the transport drum 5 on the opposite side. In FIG. 12a, for the transporting and pretreatment of the filter elements 1 the transport drums 5 are provided in a horizontal orientation and rotated about the central axis X, wherein a profiling 6 is provided in the inside for the further conveying and for the pretreatment. Instead of the thus provided horizontal orientation, the transport drum 5 can also be tilted according to FIG. 12b with a tilt at an angle α, which can be variable. The inserting of filter elements 1 takes place here too at an inlet 5.3, and by means of the incline and gravity with rotation of the transport drum 5 at the same time, the filter elements are moved further to the outlet 5.4. The advantage of this variant of a mode of operation according to the method according to the invention is that no change of direction is necessary. The rotation of the transport drum 5 can take place staying the same in one direction, and there are only relatively short filling times. Furthermore, a filling and a pretreatment and a removing of filter elements 1 can take place in parallel. The individual steps can quasi be carried out at the same time by means of the device 10 according to the invention with such a mode of operation of the transport drum 5.

FIG. 12c and FIG. 12d show two further variants of an alternating operation of the device 10 according to the invention with a change of rotation direction of the rotation of the transport drum 5, as indicated by the arrows. In FIG. 12c, a direct filling of the transport drum 5 with filter elements 1 takes place from a radial opening, for example a radial door 19 (see FIG. 6a). The emptying of the filter elements takes place, for example, via an outlet 5.4 in the rotation shadow, that is, the pretreated finished filter elements 1 are removed by means of the change of the direction of rotation of the rotation drum 5. In the embodiment of FIG. 12d, the insertion takes place via the inlet 5.3 on a right-hand side. Also, at the same time there, the removing of the filter elements 1 at the outlet 5.4 is effected by means of a reversal of direction of rotation. These two forms of a mode of operation with change of direction of rotation have the advantage that a clear processing time per load is given. Furthermore, different removal directions can be realized at the transport drum 5, in order to simplify the process in existing preceding and following units.

In FIG. 12e on the other hand, a clocked operating mode of the transport drum is shown with regard to the rotation and for the inserting and removing of the filter elements 1. The transport drum 5 is provided here with different chambers 5.5, and a change of one chamber 5.5 to the next chamber 5.5 takes place by a change of rotation direction. The untreated filter elements 1 are introduced at the inlet 5.3, and treated by means of the tilt or incline of the transport drum 5 during rotation in one direction. When the rotation direction is reversed, the filter elements are conveyed from the first chamber 5.5 into the next second chamber 5.5 and further processed there. This takes place in this embodiment by means of four different single chambers 5.5. The filter elements 1 are then removed again from the last chamber via the outlet 5.4. The advantage of this mode of operation with clocking of the rotation direction is that a parallel processing and filling is possible. Also, in this way the dwell time and thus the processing time can be controlled in a simple way by means of the clocking.

FIG. 13 shows in a schematic lateral view a further embodiment of a device 10 according to the invention for the pretreatment and transport of insertion elements for injection-molded parts like for example pipette tips. Here too, the insertion elements in the form of bulk material are first supplied from above into a supply container 2 and, as indicated by the arrows in FIG. 13, enter a transport drum 5 arranged therebelow. The transport drum 5 is here too provided with an inside profiling 6 and rotates about a rotation axis X. The insert elements (not shown in FIG. 13) introduced from the inlet 5.3 of the transport drum 5 are therefore treated in the inside by means of the rotation about the rotation axis X and a striking at the profiling 6, so that possible deformations or projecting burrs from the preceding manufacturing process are removed. The suction unit 7 therebelow serves for the removing of grains of material and dust emerging from the openings of the transport drum 5. After a determined length of time of the pretreatment in the transport drum 5, the insert elements 1 then emerge through the outlet 5.4 of the transport drum 5 and fall into a sieve plate 4, in which openings are provided like before, as described for the other embodiments. In this way, the insert elements determined as good parts, which pass through the openings of the sieve plate 4, are conveyed on. With a laterally arranged cleaning unit 13, for example in the form of a filter suction system, the bad parts are removed from the process. Alternatively or additionally, also a kind of ejector 16 can be introduced at the sieve plate 4 from below, as schematically illustrated in FIG. 13. In this further embodiment according to FIG. 13, now, after the sieve plate 4, a further means for the sorting out of bad parts is provided in the form of a sieve screen 23.

The sieve screen 23 below the sieve plate 4 is provided above the containers 3a and 3b. The insert elements 1 emerging from the sieve plate 4 are quasi caught on the sieve screen 23. For this, the sieve screen has sieve openings 24 or holes in such a shape that such insert elements 1 which are dimensioned under a lower predetermined tolerance limit, that is, have a too small dimension or are undersized, fall into the container 3a therebelow for discharged parts or onto a conveyor belt. That means, with this sieve screen 23 the too small parts are also additionally discharged and removed from the process as undersized parts. Due to the tilt of the sieve screen 23, only such good parts of the insert elements 1 continue further along in the process and in this embodiment fall into an adjacent second container 3b for good parts. Due to the tilted arrangement of the sieve screen 23, this occurs merely due to gravity. Additionally to the acceleration of the process of the discharging of undersized parts, a shaking motion can be generated at the sieve screen 23. The containers 3a (discharged parts) and 3b (good parts) in this embodiment are each also provided with funnels 3.2 extended upward in a funnel-shape. Instead of the containers 3a, 3b, also other means for the further transporting or the removing of the insert elements can be correspondingly provided.

Hereby, a further improvement in the quality of the insert elements 1 emerging from the device 10 for the pretreatment is achieved. By means of the sieve screen 23, arranged downstream from the sieve plate 4, the bad parts of the insert elements 1 fall through the sieve screen 23 as they are too small and in a determined dimension smaller than the dimension of the sieve openings 24 in the sieve screen 23. The good parts, on the other hand, are laterally diverted along the sieve screen 23 due to the tilt or incline and either fall into a container 3b for good parts or onto a conveyor belt for a downstream use in the process for the fitting of the synthetic material injection-molded parts. For this, the sieve screen 23 has specific sieve openings 24 in the form that they are smaller in at least an axial shape or dimensioning of the insert elements 1 than a predefined smallest dimension of the good parts of the insert elements 1. For example, the diameter of cylindrical insert elements 1 is set to a predetermined lower tolerance value and the openings 24 of the sieve screen 23 have a corresponding size.

The sieve screen 23 can be provided in different shapes with at least one tilted or partly tilted orientation. FIG. 13a, FIG. 13b and FIG. 13c show three exemplary variants of the feature of the device 10 according to the invention in this regard. FIG. 13a shows a sieve plate 23a, which is arranged with simple one-sided slant above a discharge container 3a for bad parts, that is, insert elements 1 which are undersized below a pre-given minimum dimension of the size of this dimension. In FIG. 13b, on the other hand, a sieve screen 23b is provided with a gable roof-shaped embodiment, so that from a middle point left and right in each case the good parts can be sorted out for further use, due to the tilt of the lateral parts of the sieve screen 23b. In FIG. 13c, a fan-like arrangement is shown at a third variant of the sieve screen 23c with likewise an altogether tilted orientation with regard to the horizontal. The insert elements 1 emerging from above from the sieve plate 4 therefore fall onto the sections, arranged fan-like, of the sieve screen 23c and are separated by means of the sieve openings 24 provided therein with the corresponding dimensions of the minimum dimension, into bad parts, into the container 3a, and for example into an adjacent container 3b for good parts.

In all of these embodiments of FIG. 13 to FIG. 13c, an additional shaking motion of the sieve screen 23 can also be provided for an increase in the speed of the sorting and efficiency of quality assurance, which however is not necessary for the basic function of this discharging method for undersized parts of the insert elements 1.

1. Method for the pretreatment of insert elements for the fitting of injection molded parts, wherein the insert elements are transported as bulk material from a supply container to a storage container, the bottom of which is formed as a sieve plate with corresponding openings or bores (4.1), into which the insert elements are transferred, comprising the steps of:
supplying the insert elements into a rotatable transport drum, which is provided with openings or through-holes of such a shape or size that the insert elements remain in the transport drum during the pretreatment;
rotating the transport drum at least intermittently around an axis X, around which the transport drum is rotatably mounted;
transporting the insert elements through the transport drum, so that the filter elements repeatedly come into contact with the inside wall of the transport drum and mutually with one another by means of a pre-determined length of time of a pretreatment; and
discharging the pretreated insert elements from the transport drum.

2. Method according to claim 1, further comprising adjusting a mean dwell time of the insert elements in the transport drum, by means of adjusting the rotation movement, rotation direction, shape, inclination and/or other movement profiles at or in the transport drum.

3. Method according to claim 2, comprising using a transport means for the transport of the insert elements, including one or more of a shape or profiling at the inside of the transport drum, an inclination of the axis X, or a control of the rotation movement of the transport drum.

4. Method according to claim 1, further comprising sorting-out of bad parts of the insert elements before or during an introducing into the storage container with the sieve plate.

5. Method according to claim 4, further comprising suctioning-off and/or discharging of bad parts at or before the sieve plate.

6. Method according to claim 1, further comprising using a pre-sorting screen for a discharging of bad parts of the insert elements after the discharging from an outlet or outlet opening of the transport drum.

7. Method according to claim 1, further comprising adjusting of a predetermined inclination of the transport drum at an angle α to the horizontal for a defined mean time-period of the pretreatment of the insert elements in the transport drum.

8. Method according to claim 1, further comprising a conveying and pre-treating of the insert elements in the transport drum by at least a helical-shaped profiling or a helical-shaped section of a profiling at the inside of the transport drum.

9. Method according to claim 1, further comprising sieving out and discharging of material particles, particles of dirt, or fragments from the process of the pretreatment of the insert elements from the transport drum via the openings or through-holes.

10. Method according to claim 1, further comprising impinging of the transport drum with compressed air from a lower side for a swirling of the insert elements during the pretreatment.

11. Method according to claim 1, further comprising an at least intermittent rotation movement of the transport drum during the process of the pretreatment of the insert elements.

12. Method according to claim 1, further comprising detection of a fill level of the storage container positioned downstream in the transport drum for a control of the amount of insert elements located in the pretreatment.

13. Device for the pretreatment of insert elements including carrying out the method according to claim 1, wherein the insert elements as bulk material are conveyed from a supply container or bunker to a storage container, wherein the bottom of the storage container is formed as a sieve plate with openings or bores, into which the insert elements are conveyed by means of shaking motions for a conveying onward or a use in the fitting process of the injection molded parts or in another subsequent process step, wherein a transport drum rotatably movable about an axis X is provided between the supply container and the storage container.

14. Device according to claim 13, wherein the transport drum is provided with openings or through-holes of a smaller diameter than that of the filter elements or of another shape or smaller dimension than the outer circumference of the insert elements.

15. Device according to claim 13, wherein the transport drum is provided at its inside at least section-wise with at least one profiling of projections and/or recesses, and for the pretreatment of the insert elements, means are provided for the automatic conveying of the insert elements through the transport drum from an inlet side to an outlet side with at least intermittent rotation of the transport drum.

16. Device according to claim 13, wherein the transport drum is provided with means for the variable adjustment of an inclined position or tilt at an angle α in relation to the horizontal, and a control unit is provided, which is formed and configured in order to variably adjust the tilt of the transport drum corresponding to the intended dwell time and length of time of the process of the pretreatment of the insert elements.

17. Device according to claim 13, wherein the transport drum is provided with means for the conveying onward of insert elements in or outside of the transport drum.

18. Device according to claim 17, wherein the means for conveying the insert elements through the transport drum are formed in the form of profilings or sections of profilings with projections and/or recesses at an inside or inner wall of the transport drum.

19. Device according to claim 13, wherein at an outer side of the transport drum, a vacuum-driven suction unit is provided for the discharging of dirt, particles, or fragments from the pretreatment of the insert elements, out from the bores or through-holes of the transport drum.

20. Device according to claim 13, wherein, at the transport drum, a pressure generation means is provided in order to impinge the insert elements through the bores or through-holes of the transport drum 5, with compressed air during the pretreatment.

21.-30. (canceled)
